(19) United States
(12) Patent Application Publication
(10) Pub. No.: US 2016/0375620 A1
(43) Pub. Date: Dec. 29, 2016

(54) Method for Manufacturing a Rigid Receptacle, In Particular Having Two Layers, Rigid Receptacle Obtained According to Said Method, and Device for Implementing Said Method

(71) Applicant: ALBEA SERVICES, Gennevilliers (FR)

(72) Inventors: Jerome Liard, Sainte-Jamme-Sur-Sarthe (FR); Emmanuel Revault, Locoal-Mendon (FR); Stephane Tourdot, Locoal-Mendon (FR); Guy Pliquet, Pluguffan (FR)

(21) Appl. No.: 15/038,916

(22) PCT Filed: Nov. 25, 2014
(86) PCT No.: PCT/EP2014/075511

§ 371 Date: May 24, 2016

(30) Foreign Application Priority Data
Nov. 28, 2013 (FR) 1361796

(51) Int. Cl. B29C 45/16; A45D 34/00; B65D 1/02

(52) U.S. Cl. CPC B29C 45/1625; B29C 45/1628; B29C 45/162; B65D 1/0215; A45D 34/00; B65D 1/023; B29L 2031/712

(57) ABSTRACT

The invention relates to a method for manufacturing a rigid receptacle (10), in particular a bottle, more particularly a bottle for a cosmetic product, said receptacle having a two-layered structure comprising a first layer, referred to as the receptacle body (20), which defines a neck (22) of said receptacle (10), and a second layer, referred to as the receptacle envelope (30), which surrounds said body (20). The method according to the invention comprises a step of shaping a preform inside a component forming said envelope (30), in order to form said body (20).

The invention also relates to a rigid receptacle (10) obtained according to said method, and to a device for implementing said method.

The invention relates to a method for manufacturing a rigid receptacle, in particular a bottle, more particularly a bottle for a cosmetic product, even more particularly a bottle for mascara, to a rigid receptacle obtained according to said method, and to a device for implementing said method.

Bottles for cosmetic products are currently made of plastics material. Bottles for receiving mascara, in particular, have to be sealed, even after they have deteriorated, for example after they have been in contact with extreme temperatures or after they have been in humid or very dry environments.

There are bottles for mascara in which the body is first injection moulded and then the neck is welded to said body. The main drawback of the neck being subsequently welded to the body of the bottle is the risk of the seal and the mechanical strength deteriorating over time. Another drawback of this type of bottle is that the range of materials that could be selected for both the body of said bottle and for the neck is restricted. Indeed, for this type of bottle, it must be possible to weld the selected materials to one another.

Bottles for mascara are also required to be highly aesthetically pleasing. Therefore, a bottle formed in one piece from a single-layered preform that is first injection moulded and then blown will be deemed unsightly by the professionals in the field.

The object of the invention is to provide a bottle for a cosmetic product, in particular for mascara, which does not have the above-mentioned drawbacks.

The invention therefore relates to a method for manufacturing a rigid receptacle, in particular a bottle, more particularly a bottle for a cosmetic product, said receptacle having a two-layered structure comprising a first layer, referred to as the receptacle body, which defines a neck of said receptacle, and a second layer, referred to as the receptacle envelope, which surrounds said body.

According to the invention, said method comprises a step of shaping a preform inside a component forming said envelope, in order to form said body.

The invention thus proposes a method which can be implemented in a simple manner and which makes it possible to obtain a receptacle which, on account of the body thereof, ensures an improved seal and improved mechanical strength by comparison with receptacles having a welded neck. The invention is also advantageous in that it proposes a receptacle which gives professionals in the field a wide selection of materials to choose from for the part in contact with the cosmetic product, i.e. the body of the bottle, while maintaining a wide choice of decorations, on account of the envelope being made of an injection-moulded material.

According to different embodiments of the invention, which can be taken together or separately:
said shaping step comprises a step of blowing the preform,
during the step of shaping said preform, said envelope is positioned for shaping said preform once the temperature of said envelope is lower than the melting temperature thereof such that said envelope is rigid or hard,
said shaping step allows said preform to be pressed against the internal wall of said envelope,
a step of injection moulding said preform precedes said shaping step,
said preform is injection moulded in a single operation, from a single layer of material, and directly to the final thickness thereof,
a step of injection moulding said envelope precedes said shaping step,
said envelope is injection moulded in a single operation, from a single layer of material, and directly to the final thickness thereof,
the steps of injection moulding said preform and injection moulding said envelope take place simultaneously,
a step of ejecting the rigid receptacle obtained by shaping said preform inside said envelope takes place after the shaping step.

Advantageously, the invention also relates to a rigid receptacle obtained according to the method as described above.

According to different embodiments of the invention, which can be taken together or separately:
said envelope forms and/or bears a decoration,
said body and/or said envelope comprise retaining means capable of keeping said body inside said envelope,
the retaining means are capable of keeping said body inside said envelope, in particular in a longitudinal extension direction of said receptacle and/or in a direction transverse to said longitudinal extension direction,
said retaining means are counter shapings on said body and/or inside said envelope,
said retaining means are formed integrally with said body and/or with said envelope,
said body is kept inside said envelope by said retaining means and by means of a connection between the material of said body and the material of said envelope,
said neck comprises a narrow portion,
the part of the receptacle comprising the narrow portion is made from a single layer of material,
the part forming the base of said receptacle is made from a single layer of material,
said body forms said base and/or the narrow portion of the receptacle,
said body is made of plastics material,
said body is made of polypropylene (PP),
said envelope is single-layered,
said envelope is non-transparent,
said envelope is made of plastics material,
said envelope is made of a plastics material from the copolyester family,
said body and said envelope are made of the same type of material.

Advantageously, the invention also relates to a device for implementing the method as described above, comprising at least:
a shaping station for shaping said preform inside said envelope.

According to different embodiments of the invention, which can be taken together or separately:
said device further comprises at least:
a first injection moulding station for injection moulding at least one said envelope,
a second injection moulding station for injection moulding at least one said preform, and/or
an ejection station for ejecting the rigid receptacle,
said device further comprises at least:
a first part, referred to as the fixed part, and
a second part, referred to as the movable part, which is movable relative to the fixed part,
said movable part is designed to be translated in a direction referred to as the device opening/closing direction and rotated about an axis coincident with said opening/closing direction,
said first injection moulding station is rigidly connected to said movable part,
said device further comprises a central part located between said fixed part and said movable part of the device,
said central part is rotatable about an axis perpendicular to said opening/closing direction, in particular when said movable part is spaced apart from said fixed part by a translational movement in said opening/closing direction,
said second injection moulding station comprises a portion of said central part which makes it possible to shape an end part of said preform and then drive said end part,
said movable part is capable of being rotated by an angle of 180° after having been subjected to said translational movement relative to said fixed part, said translation being intended for spacing said fixed and said movable parts apart from one another,
said central part has four faces, each face comprising a nozzle for injection moulding said preforms and/or an air inlet for supplying air to said blowing station,
said injection moulding, blowing and ejection stations are arranged around said central part, at 90° to one another.

The invention will be better understood, and its other aims, details, features and advantages will become clearer in the following detailed explanatory description of at least one embodiment of the invention given as a purely illustrative and non-limiting example, with reference to the accompanying diagrammatic drawings.

In these drawings:

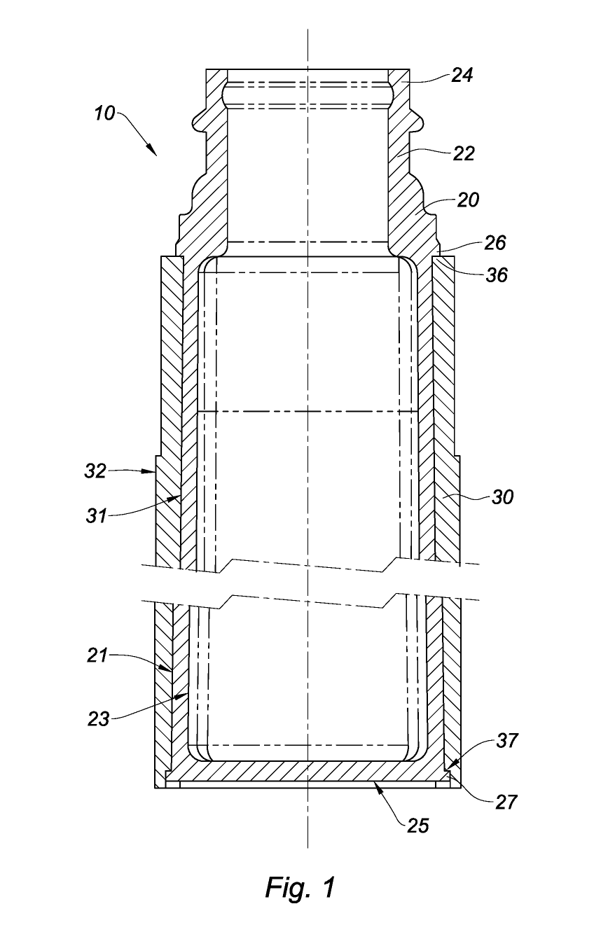

FIG. 1 is a sectional view of an embodiment of a rigid receptacle according to the invention,

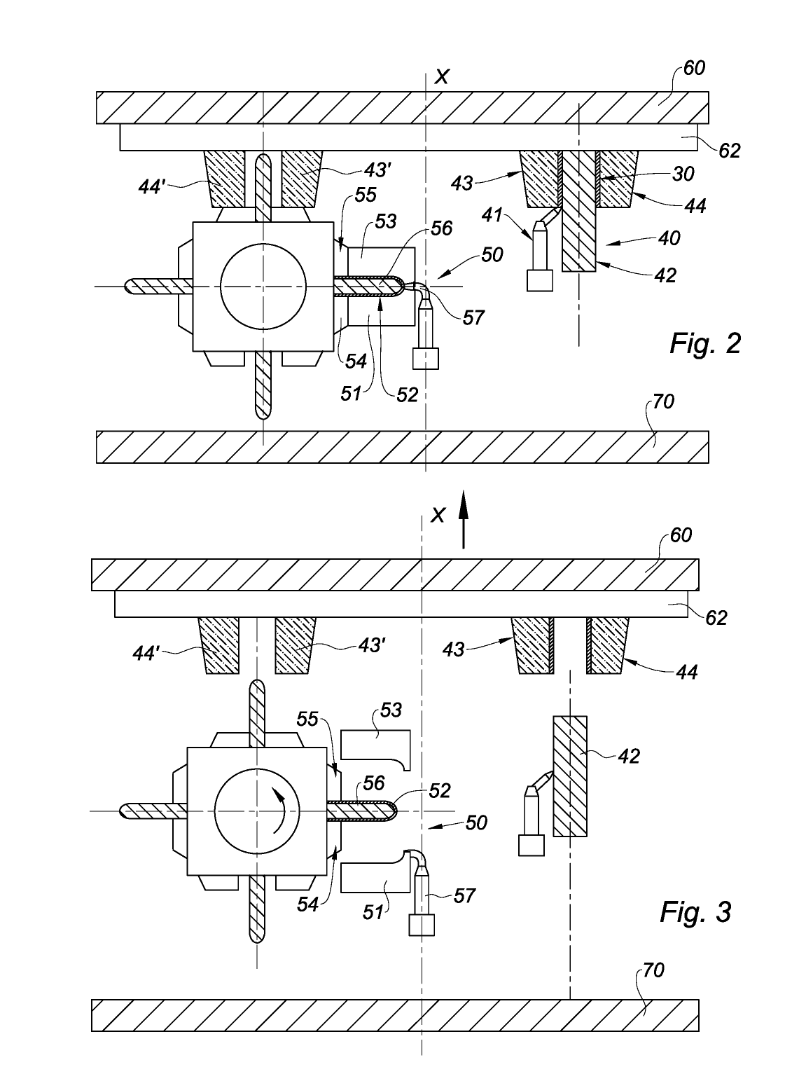

FIG. 2 is a schematic view of an embodiment of the device for implementing the method for manufacturing rigid receptacles of the type shown in FIG. 1, shown during a first manufacturing stage,

FIGS. 3 to 7 are schematic views showing the device of FIG. 2 during successive stages of the method of the invention.

The invention relates to a rigid receptacle 10, in particular a bottle, more particularly a bottle for a cosmetic product such as mascara. “Rigid” is understood to mean “undeformable”, or at least “deformable without breaking”, by comparison with a relatively flexible tube in the field of cosmetics.

As can be seen in FIG. 1, the receptacle 10 comprises a first layer, referred to as the receptacle body 20, and a second layer, referred to as the receptacle envelope 30.

The body 20 is distinctive in that it defines the neck 22 of said receptacle 10. Said body is created by shaping a preform. Said body therefore intrinsically has a certain degree of rigidity. The envelope 30, in turn, is made of an injection-moulded material and surrounds the body 20. Said envelope thus also has a certain degree of rigidity. Said envelope is therefore neither a flexible film nor a label.

The envelope 30 is advantageously intended to form or bear a decoration on the external wall 32 thereof, the internal wall 31 of said envelope being in contact with the receptacle body 20, or more precisely with the external wall 21 thereof. The intention behind this decoration is to customise said receptacle 10. The envelope 30 is preferably non-transparent.

The internal wall 23 of said body 20 in turn defines a container for the cosmetic product.

The neck 22 of said body 20 comprises in this case a narrow portion 24 having technical shapings that allow it to engage with the gripping part of a mascara brush (not shown), for example. Said narrow portion 24 is produced from a single layer of material, just like the part 25 forming the base of said receptacle 10. This means that the envelope 30 does not cover the narrow portion 24 or the base 25 which are both made of a single material and form part of said body 20.

The body 20 does not have a weld region, unlike a relatively flexible tube in the cosmetics field which has, in a known manner, at least one longitudinal weld along the main longitudinal extension direction thereof for forming said tube before filling and/or a transverse weld in a direction orthogonal to said longitudinal extension direction for forming a base of the tube after filling.

Said body 20 is in particular made of plastics material, preferably polypropylene (PP). The envelope 30 is also made of plastics material, preferably a material from the copolyester family. However, the body 20 and the envelope 30 could be made of the same material.

The body 20 advantageously has particular shapings 26, 27 for ensuring that said body is kept inside the envelope 30. These shapings 26, 27 abut complementary shapings 36, 37 that form part of said envelope 30. A first shaping 26 is located in the region of the neck 22, and a second shaping 27 is located in the region of the base 25. Said abutments prevent any movement of the envelope 30 relative to the body 20 in a direction parallel to the longitudinal extension direction of said receptacle 10.

In the case of a cylindrical receptacle 10, which may or may not have a circular cross section, said shapings 26, 27 and abutments 36, 37 could be provided over the entire circumference of said faces, or of the internal wall 21 and external wall 31.

Other shapings could be provided on the external wall 21 of the body 20 in order to prevent any movement of said body relative to the envelope 30 in a direction transverse to said longitudinal extension direction. These shapings provided on the external wall 21 of the body 20 would abut the complementary shapings produced on the internal wall 31 of said envelope 30. These complementary shapings could be counter shapings of the notch type or dovetail undercuts (not shown). They could be integrally formed with both said body 20 and said envelope 30.

It will become clear in the following that another type of connection can exist between the material of said body 20 and the material of said envelope 30 in order to ensure that said body 20 is kept inside said envelope 30.

As shown in the following figures, the invention also relates to a method for manufacturing said receptacle 10 and to a device intended for implementing said manufacturing method.

FIG. 2 is a schematic view of an embodiment of the device for manufacturing rigid receptacles of the type described above, shown during a first manufacturing stage.

This stage is referred to as the “injection moulding stage”.

The device of the invention comprises two injection moulding stations 40, 50. The first station 40 injection moulds the envelope 30, and the second station 50 injection moulds a preform 52. Said device further comprises a fixed part 70 which serves as a reference, and a movable part 60 which is movable relative to the fixed part 70. The movable part 60 is designed to be translated in a direction referred to as the device opening/closing direction; in FIGS. 2 to 7, said direction is denoted by reference sign X and corresponds to the vertical in these drawings.

Moreover, the movable part is provided with a rotary base 62. Said rotary base 62 is capable of carrying out rotational movements of 180° about said opening/closing direction X.

Said “injection moulding stage” comprises the following steps of the method according to the invention: injection moulding the preform 52 and injection moulding the envelope 30. It should be noted that the preform 52 and the envelope 30 are advantageously injection moulded in a single operation, from a single layer of material, and directly to the final thickness thereof. These injection moulding steps are preferably carried out simultaneously.

During the present “injection moulding stage”, the device of the invention is in the position referred to as the closed position.

In this case, material is injected into said first injection moulding station 40 via a first nozzle 41 around a first core 42 and between two shells 43, 44 of a first mould, said first mould being closed during injection moulding. Said two shells 43, 44 are rigidly connected to the rotary base 62. The rotary base 62 comprises another pair of shells 43′, 44′ which form a second mould. This other pair of shells 43′, 44′, which is also rigidly connected to the rotary base 62, is located so as to be diametrically opposite the first pair of shells 43, 44, specifically with respect to the articulation axis X.

Material is injected into the second injection moulding station 50 via a second nozzle 57 around a second core 56 and between two mould parts 51, 53 and two retaining parts 54, 55, said mould being closed during injection moulding.

Material is injected in the region of the first injection moulding station 40 in a direction parallel to said opening/closing direction X, and material is injected in the region of the second injection moulding station 50 in a direction perpendicular to said direction X.

FIG. 3 shows a second manufacturing stage. This stage is referred to as the “device opening stage” during which said movable part 60 is spaced apart from said fixed part 70 in said opening/closing direction X.

Since the shells 43, 43′, 44, 44′ are rigidly connected to said movable part 60, they move together with said movable part when it is translated relative to the fixed part 70.

Therefore, the opening, or translation, of the movable part 60 of the device of the invention releases the envelope 30 from the core 42 around which it has been injection moulded in the preceding stage.

The preform 52 remains around the core 56 of the second injection moulding station 50 which shaped it. Indeed, although the two mould parts 51, 53 of said second injection moulding station 50 open at the same time as the device according to the invention, the two retaining parts 54, 55 keep the preform 52 around the core 56. These retaining parts 54, 55 are located at the end opposite the end at which the injection nozzle 57 of the second injection moulding station 50 is located. As will be discussed in more detail below, said retaining parts 54, 55 are connected to a part, referred to as the central part 80, of said device. Said retaining parts surround an end of said second core 56.

In FIG. 3, the opening direction is indicated by an arrow.

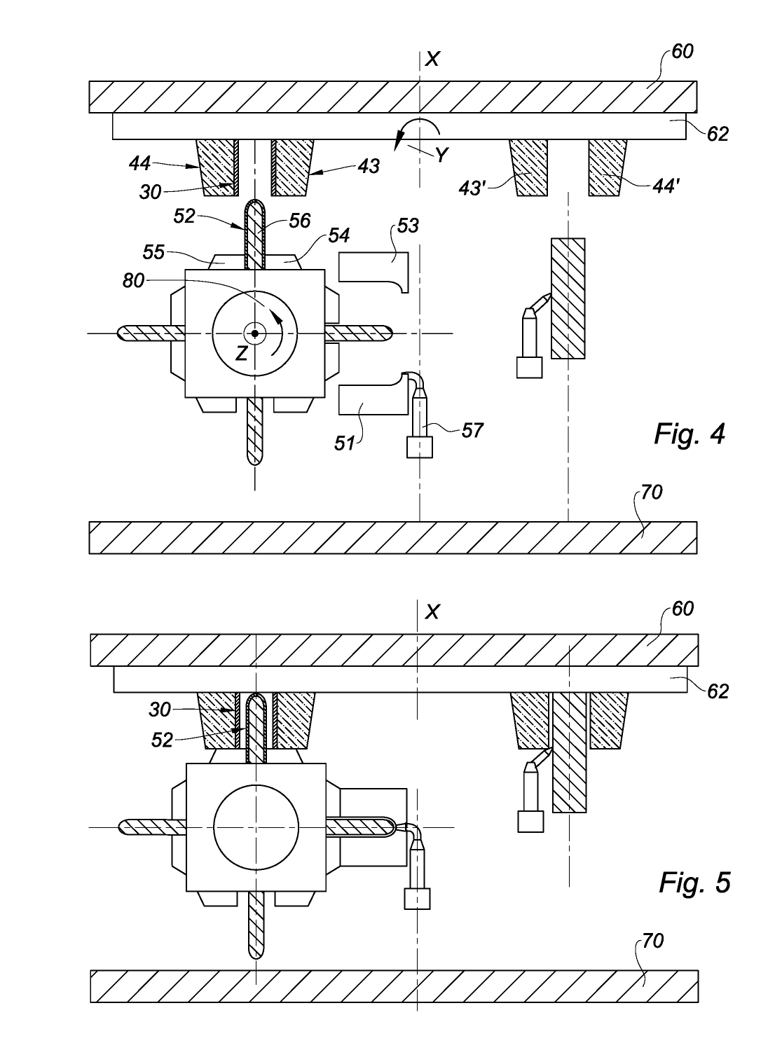

FIG. 4 shows a third manufacturing stage. This stage is referred to as the “rotation stage”.

As mentioned previously, the rotary base 62 is capable of being rotated by an angle of 180° about the direction X when said device is in the open configuration shown in FIG. 3.

In FIG. 4, the arrow Y indicates this rotation.

Although the two injection moulding stations 40, 50 of the device of the invention are at a distance from one another, said 180° rotation makes it possible to transport the first pair of shells 43, 44 containing the envelope 30 that has just been injection moulded therein to the region of the second injection moulding station 50.

More particularly, said injection moulding station 50 engages with the central part 80 that has already been mentioned. Said central part 80 is located between said fixed part 70 and said movable part 60 of the device. The shells 43, 44 are transported to the region of this central part 80 after having rotated in direction X.

Said central part 80 has four faces, each face comprising a core 56, referred to as the second core, for injection moulding preforms such as the preform 52 in the mould 50. Moreover, said cores comprise an air inlet for supplying them with air in order to blow the preform 52 after it has been injection moulded in the manner set out above.

Said central part 80 is rotatable about an axis perpendicular to said opening/closing direction X. In FIG. 4, said perpendicular axis is denoted by reference sign Z.

During the opening, or translation, of the device as described with reference to the “device opening stage”, said central part is rotated by 90° about said axis Z, in this case in an anticlockwise direction. Therefore, the second core 56 of the second injection moulding station 50 and the preform 52 which is retained therein by means of the retaining parts 54, 55 are also rotated by 90°. The preform 52 that has been injection moulded in a direction perpendicular to the opening/closing direction X is therefore parallel to the same direction X.

On account of the central part 80 rotating by an angle of 90°, and the rotary base 62 rotating by 180°, the injection moulded envelope 30 can be displaced and positioned in the axis of the preform 52.

The retaining parts 54, 55 of the preform 52 remain closed during this movement, as do the shells 43, 44 which form the mould in which the envelope 30 is located.

FIG. 5 shows a fourth manufacturing stage. This stage is referred to as the “device closing stage”.

The movable part 60 is translated in a direction X in order to bring the device of the invention into the closed position. The preform 52 is thus housed inside the envelope 30.

The device is also once again in a position for repeating the injection moulding cycle so as to produce another envelope and another preform (see “injection moulding stage”).

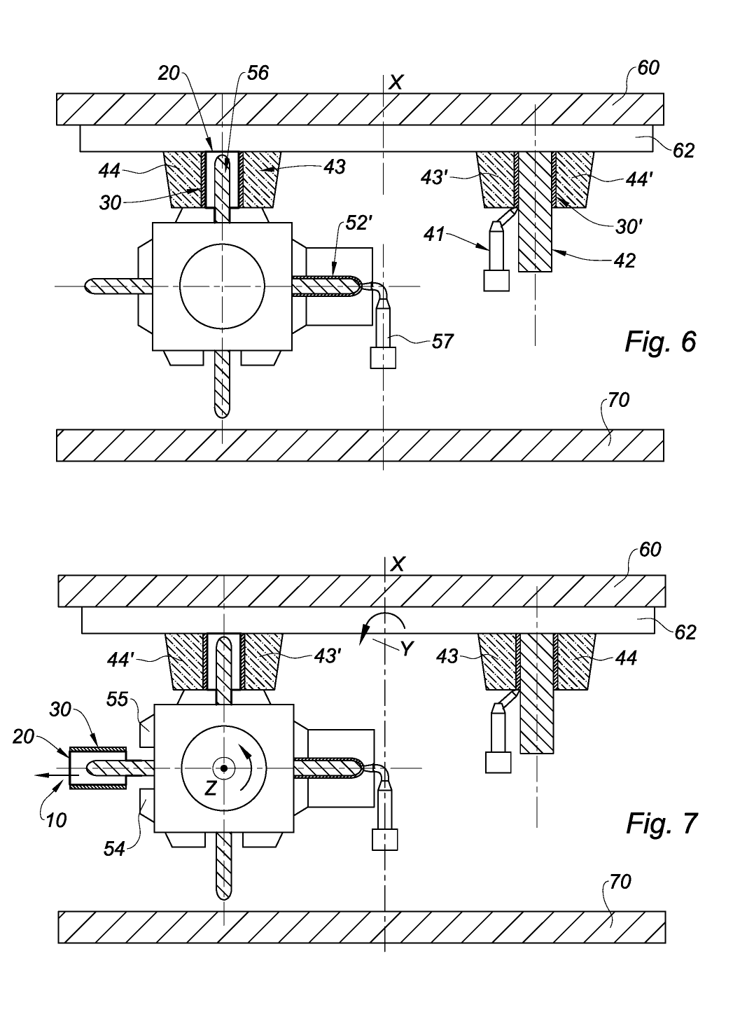

FIG. 6 shows a fifth manufacturing stage. This stage is referred to as the “preform shaping stage”.

Once the preform 52 is housed inside the envelope 30, it is blown and deformed inside said envelope 30 until it is shaped. Said preform 52 thus becomes the body 20 of the rigid receptacle 10. Indeed, said blowing step allows said preform 52 to be pressed against the internal wall 31 of said envelope 30.

It should be noted that the envelope 30 is positioned for the shaping of said preform 52 once the temperature of said envelope is lower than the melting temperature thereof such that said envelope is rigid at this point in time.

In order to improve the productivity of the overall device of the invention, another envelope 30′ and another preform 52′ are advantageously injection moulded (see “injection moulding stage”) at the same time as the first preform 52 is shaped.

The blown body 20 is kept inside the envelope 30 by the retaining means already mentioned, the shaping of which is ensured by the profile given to the moulding cavity. As a reminder, said retaining means are, inter alia, the technical shapings 26, 27 that form part of the body 20 and engage with the abutments 36, 37 of the envelope 30.

If the body 20 and the envelope 30 are made of the same material or of materials selected for this purpose, the external wall 21 of the body 20 and the internal wall 31 of the envelope 30 could be connected by chemical bonding. This connection can be added to the above-mentioned retaining means in order to ensure that the body 20 is kept inside the envelope 30. Alternatively, said connection can be a substitute for said retaining means.

It is also possible to decide to manufacture the body 20 and the envelope 30 using two different materials. If the shrinkage of the material selected for injection moulding the body 20 (for example 2%) is greater than that of the material selected for injection moulding the envelope (for example 0.5%), the above-mentioned retaining means will be essential for ensuring that the body 20 remains inside the envelope 30. Indeed, this situation would result in the body 20 shrinking too much by comparison with the envelope 30, and this would lead to the two components becoming disconnected.

FIG. 7 shows the final manufacturing stage. This stage is referred to as the “receptacle ejecting stage”.

The receptacle 10 is a finished product that has to be ejected from the device of the invention. Therefore, the retaining parts 53, 54 move apart from one another in order to free the region of the preform that they have been retaining thus far, and so the receptacle 10 can be ejected. The region of the preform that has thus far been retained by means of the parts 53, 54 is advantageously the neck 22 of the receptacle 10. Said parts could in particular make it possible to produce a thread or shapings for latching a cap.

The finished part can be ejected while another preform undergoes the preceding stage referred to as the “preform shaping stage”, the device being in the closed position. Before this, the central part 80 is rotated by 90° once again; the device of the invention is thus in the open position, the receptacle 10 of the invention thus being transported to the face opposite the first injection moulding station with respect to the axis Z.

1. Method for manufacturing a rigid receptacle said receptacle having a two-layered structure comprising a first layer, referred to as the receptacle body, which defines a neck of said receptacle, and a second layer, referred to as the receptacle envelope, which surrounds said body, said method comprising step of shaping a preform inside a component forming said envelope, in order to form said body.

2. Manufacturing method according to claim 1, wherein a step of injection moulding said preform precedes said step of shaping the preform.

3. Manufacturing method according to claim 2, wherein said preform is injection moulded in a single operation, from a single layer of material, and directly to the final thickness thereof.

4. Manufacturing method according to claim 1, wherein a step of injection moulding said envelope precedes said shaping step.

5. Manufacturing method according to claim 4, wherein said envelope is injection moulded in a single operation, from a single layer of material, and directly to the final thickness thereof.

6. Manufacturing method according to claim 4, wherein the steps of injection moulding said preform and of injection moulding said envelope take place simultaneously.

7. Manufacturing method according to claim 1, wherein a step of ejecting the product obtained by shaping said preform inside said envelope takes place after said step of shaping the preform.

8. Rigid receptacle obtained using the method according to claim 1.

9. Receptacle according to claim 8, wherein said body, and/or said envelope comprise retaining means capable of keeping said body inside said envelope.

10. Receptacle according to claim 9, wherein said retaining means are counter shapings formed integrally with said body and/or said envelope.

11. Receptacle according to claim 8, wherein said receptacle comprises a base produced from a single layer of material, said body forming said base.

12. Device for implementing the method according to claim 1, comprising at least:
a shaping station for shaping said preform inside said envelope.

13. Device according to claim 12, further comprising at least:
a first injection moulding station for injection moulding at least one said envelope,
a second injection moulding station for injection moulding at least one said preform,
an ejection station for ejecting the rigid receptacle,
a first part, referred to as the fixed part,
a second part, referred to as the movable part, which is movable relative to the fixed part, said movable part being designed to be translated in a direction referred to as the device opening/closing direction (X) and rotated about an axis coincident with said opening/closing direction (X), said first injection moulding station being rigidly connected to said movable part, and
a central part located between said fixed part and said movable part of the device, said central part being capable of serving at least said second injection moulding station and/or said shaping station and/or said ejection station.

14. Device according to the claim 13, wherein said central part is rotatable about an axis (Z) perpendicular to said opening/closing direction (X).

15. Device according to claim 13, wherein said second injection moulding station comprises a portion of said central part which makes it possible to shape an end part of said preform and to then drive said end part.

16. Manufacturing method according to claim 5, wherein the steps of injection moulding said preform and of injection moulding said envelope take place simultaneously.

17. Device according to claim 14, wherein said second injection moulding station comprises a portion of said central part which makes it possible to shape an end part of said preform and to then drive said end part.
